(19) United States
(12) Patent Application Publication
(10) Pub. No.: US 2012/0312741 A1
(43) Pub. Date: Dec. 13, 2012

(54) Plate settler

(75) Inventors: Gary Pashaian, Monroe, MI (US); Adam Pashaian, Monroe, MI (US)

(73) Assignee: Monroe Environmental Corporation, Monroe, MI (US)

(21) Appl. No.: 13/385,321

(22) Filed: Feb. 15, 2012

Related U.S. Application Data
(60) Provisional application No. 61/520,522, filed on Jun. 10, 2011.

(51) Int. Cl. B01D 21/02

(52) U.S. Cl. 210/521

(57) ABSTRACT

A plate settler arrangement for a liquid clarification system is disclosed. The plate settler is disposed in a clarification tank or basin in a liquid clarification system. Liquid flows into the space between adjacent plates and out of the basin through outlet members disposed in the upper region of the spaces between the plates.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX

Not applicable.

### BACKGROUND OF THE INVENTION

1. Field of the Invention

The invention relates to liquid treatment and it relates particularly to a plate settler apparatus used to facilitate the settling of solids in a liquid clarifier.

2. Description of the State of the Art

Liquid clarification systems using parallel plates to facilitate particle settlement are known. In general, parallel plates are supported in liquid clarification basins having a liquid inlet and a liquid outlet. The plates contribute to and facilitate the agglomeration and settling of suspended particles while the liquid is in the basin.

### BRIEF DESCRIPTION OF THE SEVERAL VIEWS OF THE DRAWING

FIG. 1 is a perspective view of an array of plate settler modules;

FIG. 2 is a close-up perspective view showing portions of plate settler modules including outlets and a portion of a weir that receives liquid from the outlets;

FIG. 3 is a detailed view of the portion of FIG. 1 labeled “3” showing some liquid inlet detail;

FIG. 4 is a side view showing some inlet detail in a second iteration;

FIG. 5 is a detailed view of the portion of FIG. 6 labeled “5” showing some liquid outlet detail;

FIG. 6 is a side view taken along the line 6-6 of FIG. 1; and

FIG. 7 is a perspective view of a plate module, partially cut-away showing flow paths associated with graduated inlet apertures.

### DETAILED DESCRIPTION OF REPRESENTATIVE EMBODIMENTS OF THE INVENTION

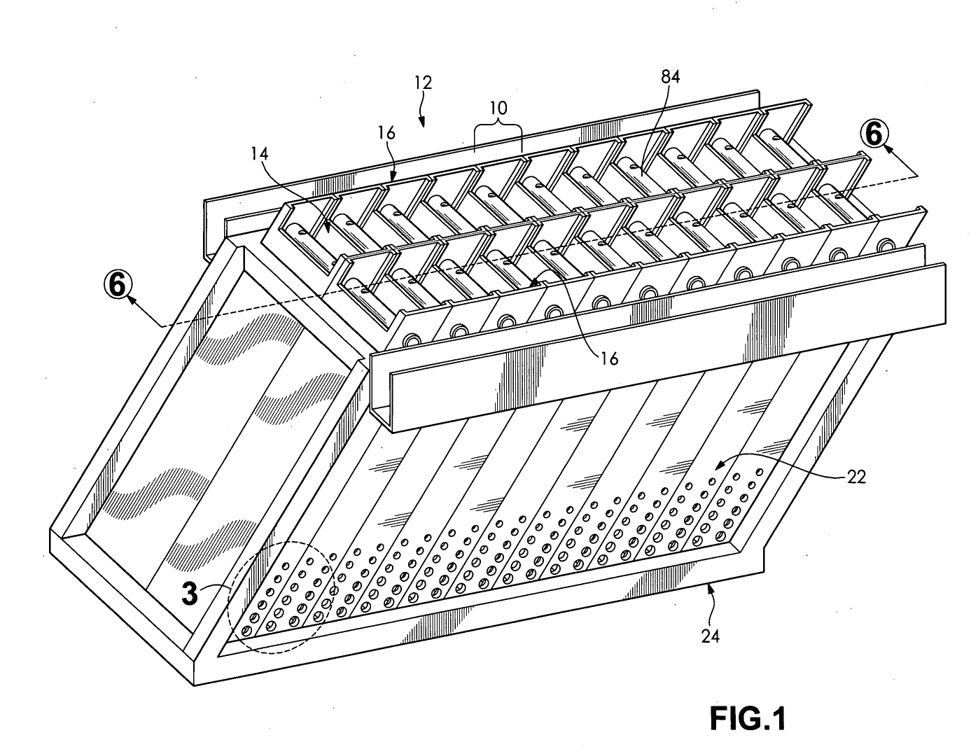

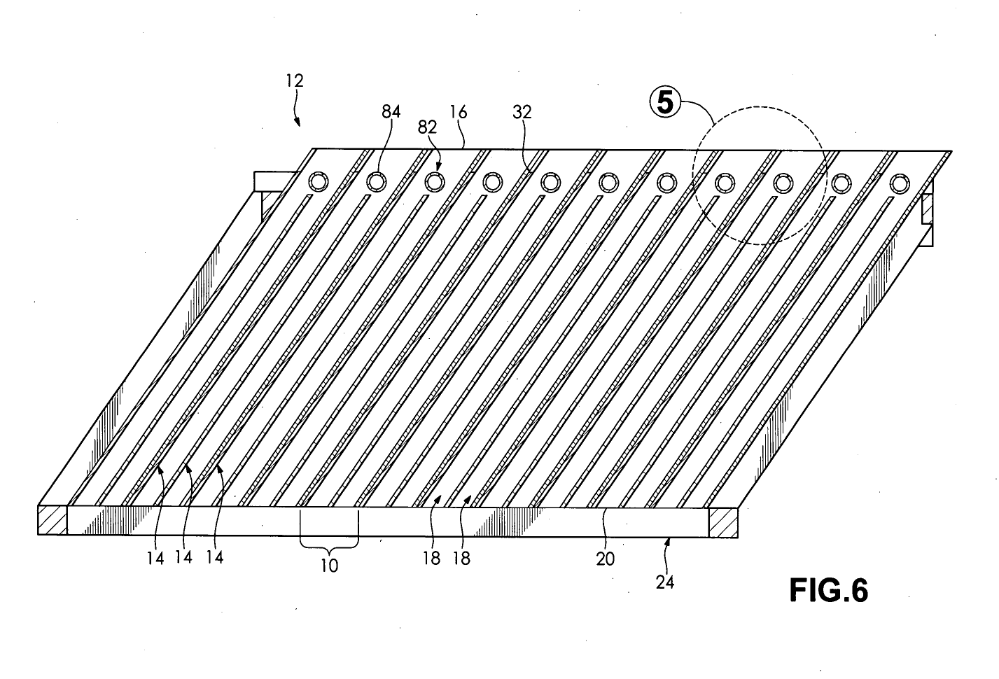

Referring now to FIGS. 1, 2 and 6, a plurality of plate separator modules 10 are arranged in a plate separator module array indicated at 12. The array 12 comprises a plurality of settler plates indicated at 14 in FIGS. 1 and 6. The plates 14 together with channel sides 16 define a plurality of fluid flow channels indicated at 18. The fluid flow channels 18 are open at the bottom and liquid in the basin enters the fluid flow channels 18 from the bottom 20 of the modules 10. The channel sides 16 are provided with fluid inlets indicated generally at 22 through which liquid also enters the fluid flow channels 18. The modules 10 are supported in a framework indicated generally at 24.

In FIGS. 1, 2 and 7, it is seen that the channel sides 16 are U-shaped with a transversely extending first, front or leading flange 30, a transversely extending second, rear or trailing flange 32 and a longitudinally extending side wall 34 connecting the flanges 30 and 32. The first, leading flange 30 is connected to an opposed first leading flange 36 by a first leading front plate 38 having an upper edge 40 which is below an upper edge 42 of the flange 30. The flange 30 together with the opposed flange 36 and the plate 38 may be an integral element in a module 10.

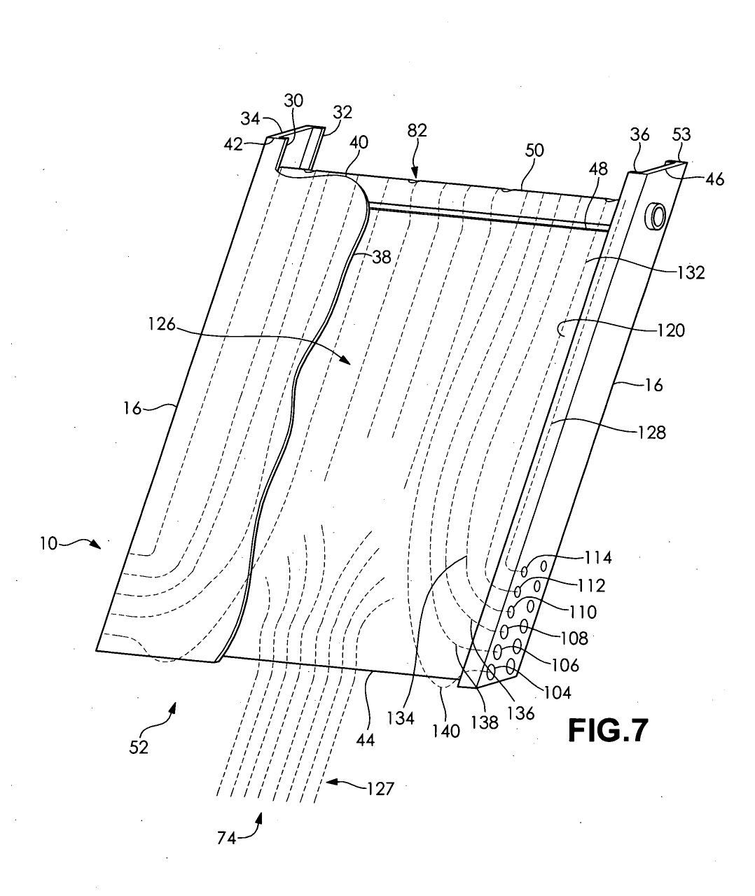

A second trailing central plate 44 extends from the side wall 34 to an opposed side wall 46 and it may be secured to and supported by the side walls 34 and 46. The plate 44 has an upper edge 48 adjacent to or in contact with a hollow channel outlet member 50 which may be supported by and may extend through the side walls 34 and 46. A first module 52 (FIG. 5) may be comprised of the flanges 30 and 36, the second flange 32 and an opposed flange 53 (FIG. 7), the side walls 34 and 46, the first plate 38, the second plate 44, and the hollow channel outlet member 50. A second module 54 (FIG. 5) adjacent to the first module 52 may be comprised of a first flange 56 and an opposed flange (not shown in FIG. 5), a second flange 58 and an opposed flange (not shown in FIG. 5), a side wall 60 and an opposed side wall (not shown in FIG. 5), a third plate 62, a fourth plate 64 and an outlet member 66.

The side wall 34 may be considered to be comprised of a first channel side 70 between the plates 38 and 44 and a corresponding laterally opposed second channel side (not shown in FIG. 5) also between the plates 38 and 44. Similarly, the side wall 34 may be considered to be further comprised of a third channel side 72 between the plates 44 and 62 and a corresponding laterally opposed fourth channel side (not shown in FIG. 5). Thus, it is seen that a first fluid flow channel 74 is defined between the plates 38 and 44 and also between the first channel side 70 and a corresponding opposed second channel side (not shown in FIG. 5). Further, it is seen that a second fluid flow channel 76 is defined between the plates 44 and 62 and also between the third channel side 72 and a corresponding opposed fourth channel side (not shown in FIG. 5). In the same manner, third and fourth fluid flow channels 78 and 80 are defined in the second module 54.

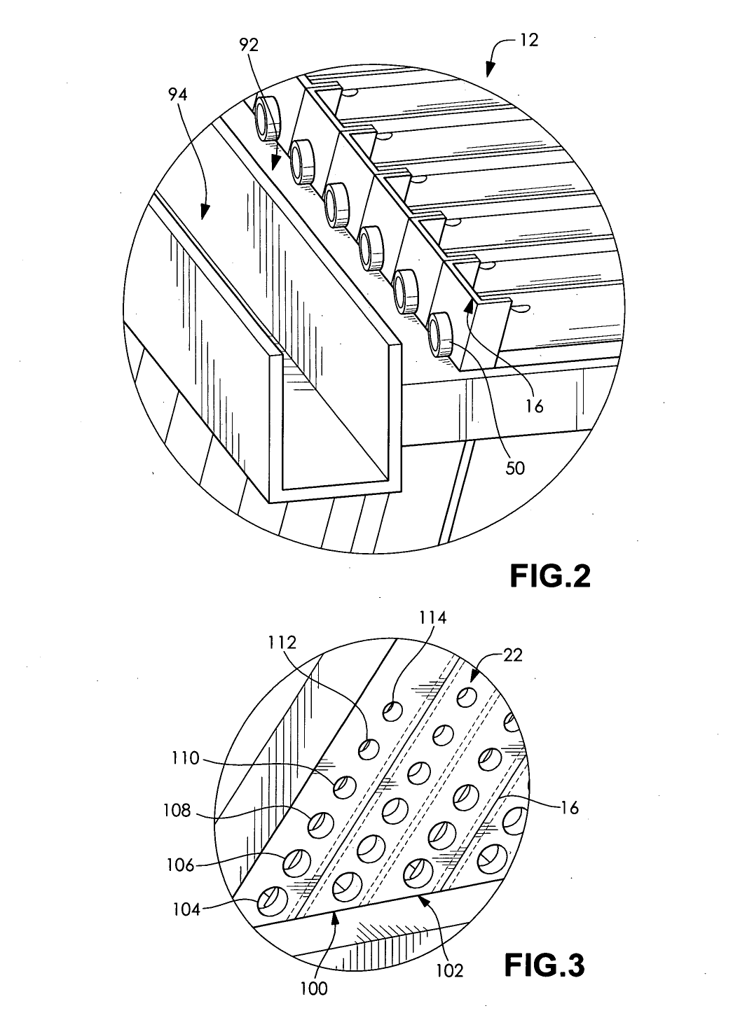

As previously mentioned, liquid enters the fluid flow channels from the bottom 20 and the side channel fluid inlets 22. In the first module 52, fluid exits the channels 74 and 76 through the hollow channel outlet member 50. The plate 44 is common to both of the channels 74 and 76. The outlet member 50 is above the plate 44 which, as illustrated in FIG. 5, terminates just below the outlet member 50. The upper edge 48 of the plate 44 may extend up to and in contact with the outlet 50 whereby two completely separate flow channels 74 and 76 would be defined. In either case, liquid flowing upwardly in fluid flow channel 74 enters the outlet tube 50 through at least one liquid inlet 82 formed in the tube 50. In FIG. 5, the liquid inlet 82 is formed in an upper surface 84 of the tube 50 although the inlet 82 can be positioned other than at the upper surface 84. In practice, it is desirable to have a plurality of inlets 82 in the outlet member 50, spread out along the length of the outlet member 50. The inlets can have a circular shape, as shown in FIGS. 1 and 2, or another shape. In FIG. 5, the inlet 82 is shown to have an edge 86 that is closest to the first channel 74 and an edge 88 that is closest to the second channel 76. The edges 86 and 88 are aligned horizontally with each other and this promotes a smooth even flow from both of the flow channels 74 and 76 into the outlet tube 50. A smooth flow is desired in order to inhibit turbulence because turbulence can inhibit the settling of solids from the liquid. By limiting turbulence, settling of particles is facilitated.

The plate 38 extends upwardly so that upper edge 40 is higher than the upper edge 48 of the plate 44. In a like manner, the plate 62 extends upwardly so that an upper edge 90 is higher than the upper edge 48 of the plate 44. That the plates 38 and 62 extend upwardly at least this high serves to define better the flow channels 74 and 76 and to demarcate the flow channel 76 from adjacent flow channel 78 and to demarcate flow channel 74 from an adjacent flow channel (not shown) positioned to the left of channel 74 in FIG. 5.

In FIG. 5, the plate 38 extends upwardly so that upper edge 40 is as high as the hollow outlet member 50. In a like manner, the plate 62 extends upwardly so that the upper edge 90 is as high as the hollow outlet member 50. That the plates 38 and 62 extend upwardly so that the upper edges 40 and 90 are as high as the hollow channel outlet member 50 serves to define better the flow channels 74 and 76 and to further demarcate the flow channel 76 from adjacent flow channel 78 and to demarcate flow channel 74 from an adjacent flow channel (not shown) positioned to the left of channel 74.

In FIG. 5, it can be seen that the plate 38 extends upwardly so that upper edge 40 is as high as the upper surface 84 of the hollow outlet member 50. In a like manner, the plate 62 extends upwardly so that the upper edge 90 is as high as the upper surface 84 of the hollow outlet member 50. That the plates 38 and 62 extend upwardly so that the upper edges 40 and 90 are as high as the upper surface 80 of the hollow channel outlet member 50 serves to define even better the flow channels 74 and 76 and to further demarcate the flow channel 76 from adjacent flow channel 78 and to demarcate flow channel 74 from an adjacent flow channel (not shown) positioned to the left of channel 74.

The outlet members can serve the additional function of supporting a maintenance worker or an inspector without interference from the plates 38, 62 and so on if the upper edges 40 and 90 extend upwardly no further than the upper surface 84 of the hollow outlet member 50, the outlet member 66 and so on. Notwithstanding the advantages accruing from limiting the height of the plates as aforesaid, one or more of the plates may have an upper edge which extends upwardly beyond any portion of the outlets 50, 66 and so on.

In FIG. 2, it is shown that liquid entering the inlet 82 of the hollow channel outlet member 50 flows out of the member 50 into a trough 92 from which it can flow into an outlet launder or trough 94 and out of the associated basin, having been clarified along the way. Liquid flowing out of the hollow channel outlet member 50 may exit the clarifier through other structures whether known or later developed.

In addition to the liquid inlets constituted by the open lower ends 20 of the fluid flow channels 74, 76, 78 and so on, additional liquid inlets indicated generally at 22 are provided in the channel sides 16. In FIG. 3, it is seen that a plurality of liquid inlets 22 are provided and that a first plurality of liquid inlets 22 are associated with a first flow channel 100 and that a second plurality of liquid inlets 22 are associated with a second flow channel 102 that is adjacent to the flow channel 100. The liquid inlets in the first plurality of inlets 22 are graduated. The opening of a first, bottom inlet 104 has a given area. The opening of a second inlet 106 adjacent to the first inlet 104 has a second given area which is smaller than the first given area. The opening of a third inlet 108 adjacent to the second inlet 106 has a third given area which is smaller than the second given area. The opening of a fourth inlet 110 adjacent to the third inlet 108 has a fourth given area which is smaller than the third given area. The opening of a fifth inlet 112 adjacent to the fourth inlet 110 has a fifth given area which is smaller than the fourth given area. The opening of a sixth inlet 114 adjacent to the fifth inlet 112 has a sixth given area which is smaller than the fifth given area.

The graduated channel side inlets 104, 106, 108, 110, 112 and 114 contribute to enhanced, less turbulent liquid flow characteristics in the region between adjacent plates. Flow studies have been conducted for the configuration shown in FIG. 3 and the study results are illustrated schematically in FIG. 7 with reference to module 52. The first plate 38 is partially broken away to reveal the second plate 44 which, together with opposed channel sides 16, define the flow channel 74. Liquid entering the flow channel 74 through the open bottom of the flow channel 74 travels a flow path which is indicated generally at 126. Liquid also enters the flow channel 74 through the channel side inlets 104, 106, 108, 110, 112 and 114. Solid particles in the liquid agglomerate and settle out of the liquid as it flows in to and upwardly in the flow channel 74. Settling solids leave the flow channel 74 in a downward path indicated generally at 127.

Liquid entering the flow channel 74 through the inlet 114 flows in a path indicated generally at 128 and this path begins with flow generally towards the center of the flow channel 74 and, within a first given short distance, this flow path changes direction and the direction of flow is generally upward towards the hollow outlet member 50.

Liquid entering the flow channel 74 through the inlet 112 flows in a path indicated generally at 132 and this path begins with flow generally towards the center of the flow channel 74 and, within a second given short distance, this flow path changes direction and the direction of flow is generally upward towards the hollow outlet member 50. The second given distance is greater than the first given distance.

Liquid entering the flow channel 74 through the inlet 110 flows in a path indicated generally at 134 and this path begins with flow generally towards the center of the flow channel 74 and, within a third given short distance, this flow path changes direction and the direction of flow is generally upward towards the hollow outlet member 50. The third given distance is greater than the second given distance.

Liquid entering the flow channel 74 through the inlet 108 flows in a path indicated generally at 136 and this path begins with flow generally towards the center of the flow channel 74 and, within a fourth given short distance, this flow path changes direction and the direction of flow is generally upward towards the hollow outlet member 50. The fourth given distance is greater than the third given distance.

Liquid entering the flow channel 74 through the inlet 106 flows in a path indicated generally at 138 and this path begins with flow generally towards the center of the flow channel 74 and, within a fifth given short distance, this flow path changes direction and the direction of flow is generally upward towards the hollow outlet member 50. The fifth given distance is greater than the fourth given distance.

Liquid entering the flow channel 74 through the inlet 104 flows in a path indicated generally at 140 and this path begins with flow generally towards the center of the flow channel 74 and, within a sixth given short distance, this flow path changes direction and the direction of flow is generally upward towards the hollow outlet member 50. The sixth given distance is greater than the fifth given distance.

The flow pattern created by the flow paths 128, 130, 132, 134, 136, 138 and 140 involves very little turbulence because the individual flow paths do not intersect or overlap each other. In contrast, flow patterns created when liquid flows through channel side inlets defined by openings which have substantially the same areas generate more turbulence, by comparison. Those flow patterns involve substantial turbulence due to the intersection and overlapping of individual flow paths of liquid entering a flow channel between two plates through such inlets. Turbulence within the flow channel has a detrimental effect on the agglomeration and settling of particles carried by liquid in the system. Accordingly, it will be seen that the graduated channel side inlets lead to better settling properties by comparison with channel side inlets that are not graduated in size with the largest inlet at the bottom of the channel side. In other words, the graduated nature of the size or area of the openings constituting the inlets 104 through 114 lead to reduced turbulence and better settling of particles and even a better rate of settling of particles.

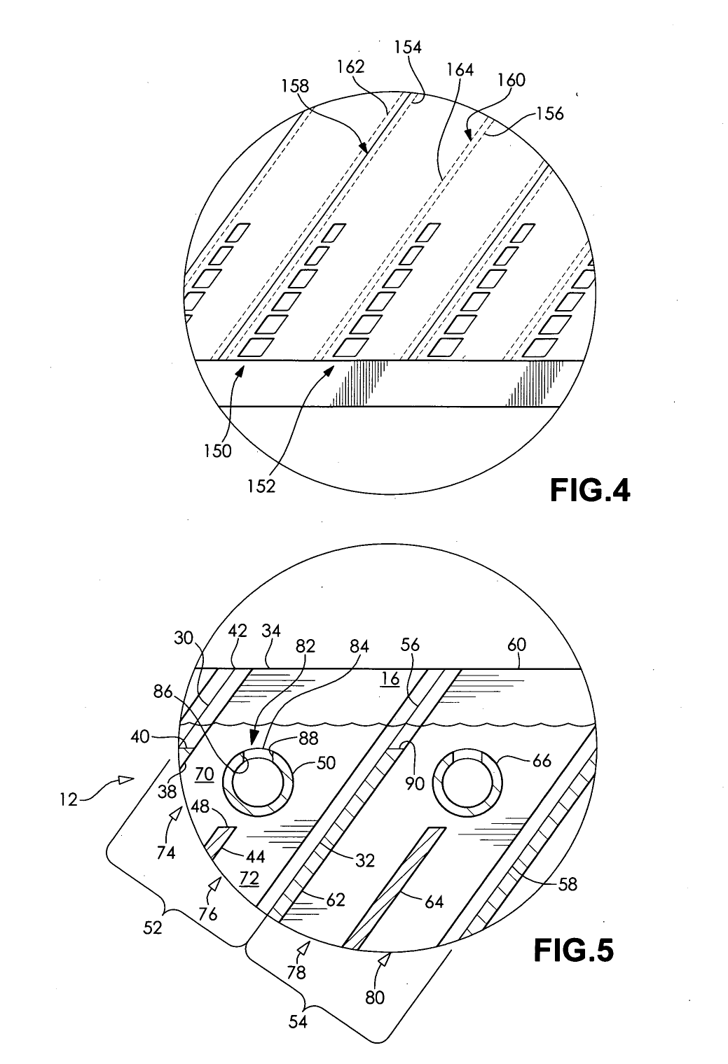

In FIG. 4, first graduated channel side inlets are indicated generally at 150 and second graduated channel side inlets are indicated generally at 152. The openings defining the first and second side inlets 150 and 152 have the shape of a convex quadrilateral, but the shape of the openings is not as significant as the graduated size of the openings. It is significant that the openings are graduated in size with the larger or largest opening adjacent to the bottom of the side channel sides. It is also significant when, as illustrated in FIG. 4, the inlets 150 and 152 are closer to bottom surfaces 154 and 156 of first and second adjacent plates 158 and 160, respectively. Most of the agglomeration of particles takes place on or near top surfaces 162 and 164 of the plates 158 and 160, respectively. By creating a pattern of flow that causes more flow closer to the bottom surfaces 154 and 156 and less flow closer to the upper surfaces 162 and 164, turbulence at or near the upper surfaces is reduced by comparison with turbulence at or near the undersides 154 and 156. By reducing turbulence at or near upper surfaces where most of the agglomeration and settling occurs, clarification is enhanced.

It will be apparent to the artisan that the present invention is susceptible of numerous variations from the details described above and illustrated in the various drawing figures. Therefore, notice is hereby given that the invention is not to be limited by the terms of the foregoing description but only by the spirit and scope of the invention as described above and defined in the claims appended hereto.

We claim:

1. A plate settler system comprising
a basin having a fluid inlet and a fluid outlet
a first plate supported in said basin and having a lower edge, an upper edge, an upwardly facing settling side and a downwardly facing flow directing side,
a second plate supported in said basin in parallel spaced relationship with said first plate, said second plate having a lower edge, an upper edge, an upwardly facing settling side and a downwardly facing flow directing side,
a third plate supported in said basin in parallel spaced relationship with said second plate, said third plate having a lower edge, an upper edge, an upwardly facing settling side and a downwardly facing flow directing side,
first and second channel sides cooperating with said first and second plates to define a first fluid flow channel between said first plate and said second plate, said first fluid flow channel having an inlet and an outlet,
third and fourth channel sides cooperating with said second and third plates to define a second fluid flow channel between said second plate and said third plate, said second fluid flow channel having an inlet and an outlet, and
a hollow channel outlet member supported in said basin and having at least one fluid inlet and at least one fluid outlet,
wherein said outlet member fluid outlet is in communication with said basin fluid outlet,
wherein said outlet member is positioned above said second plate, and
wherein fluid flowing upwardly in said first fluid flow channel and fluid flowing upwardly in said second fluid flow channel enters said at least one fluid inlet.

2. The system claimed in claim 1 wherein said hollow channel outlet member is positioned directly above said upper edge of said second plate.

3. The system claimed in claim 2 wherein said hollow channel outlet member is in contact with said second plate.

4. The system claimed in claim 2 wherein said upper edge of said first plate and said upper edge of said third plate are higher than the upper edge of said second plate.

5. The system claimed in claim 4 wherein said hollow channel outlet member and said first plate are supported in said basin so that the upper edge of said first plate is at least as high as said at least one fluid inlet.

6. The system claimed in claim 5 wherein said hollow channel outlet member and said third plate are supported in said basin so that the upper edge of said third plate is at least as high as said at least one fluid inlet.

7. The system claimed in claim 3 wherein said upper edge of said first plate and said upper edge of said third plate are higher than the upper edge of said second plate.

8. The system claimed in claim 7 wherein said hollow channel outlet member and said first plate are supported in said basin so that the upper edge of said first plate is at least as high as said at least one fluid inlet.

9. The system claimed in claim 8 wherein said hollow channel outlet member and said third plate are supported in said basin so that the upper edge of said third plate is at least as high as said at least one fluid inlet.

10. The system claimed in claim 1
wherein said first and second channel sides each have a lower edge and an upper edge,
wherein said first and second spaced plates each has an upwardly facing settling side and a downwardly facing flow directing side,
wherein there is
a major fluid inlet between said lower edges of said first and second spaced plates, and
wherein there are
first and second minor fluid inlets in said first channel side,
said first minor fluid inlet in said first channel side being positioned adjacent to said lower edge of said first channel side and adjacent to said downwardly facing flow directing side of said first plate,
said second minor fluid inlet in said first channel side being positioned between said first minor fluid inlet and said upper edge of said first channel side and being positioned adjacent to said downwardly facing flow directing side of said first plate.

11. The system claimed in claim 1
wherein said first and second channel sides each have a lower edge and an upper edge,
wherein said first and second spaced plates each has an upwardly facing settling side and a downwardly facing flow directing side,
wherein there is
a major fluid inlet between said lower edges of said first and second spaced plates,
wherein there are
first and second minor fluid inlets in said first channel side,
said first minor fluid inlet in said first channel side being positioned adjacent to said lower edge of said first channel side
said second minor fluid inlet in said first channel side being positioned between said first minor fluid inlet and said upper edge of said first channel side and
wherein said first minor inlet is larger than said second minor inlet.

12. The system claimed in claim 10 wherein there are
first and second minor fluid inlets in said second channel side,
said first minor fluid inlet in said second channel side being positioned adjacent to said lower edge of said second channel side and being positioned adjacent to said downwardly facing flow directing side of said first plate,
said second minor fluid inlet in said second channel side being positioned between said first minor fluid inlet and said upper edge of said second channel side and being positioned adjacent to said downwardly facing flow directing side of said first plate.

13. The system claimed in claim 11
wherein there are
first and second minor fluid inlets in said second channel side,
said first minor fluid inlet in said second channel side being positioned adjacent to said lower edge of said second channel side
said second minor fluid inlet in said second channel side being positioned between said first minor fluid inlet and said upper edge of said second channel side and
wherein said first minor inlet is larger than said second minor inlet.

14. The system claimed in claim 1
wherein said first and second channel sides each have a lower edge and an upper edge,
wherein said first and second spaced plates each has an upwardly facing settling side and a downwardly facing flow directing side,
wherein there is
a major fluid inlet between said lower edges of said first and second spaced plates, and
wherein there are
first and second minor fluid inlets in said first channel side,
said first minor fluid inlet being positioned adjacent to said lower edge of said first channel side and adjacent to said downwardly facing flow directing side of said first plate,
said second minor fluid inlet being positioned between said first minor fluid inlet and said upper edge of said first channel side and positioned adjacent to said downwardly facing flow directing side of said first plate, and
said first minor inlet being larger than said second minor inlet.

14. The system claimed in claim 1
wherein there are
first and second minor fluid inlets in said first channel side,
first and second minor fluid inlets in said second channel side,
said first minor fluid inlet in said first channel side being positioned adjacent to said lower edge of said first channel side and adjacent to said downwardly facing flow directing side of said first plate,
said first minor fluid inlet in said second channel side being positioned adjacent to said lower edge of said second channel side and adjacent to said downwardly facing flow directing side of said first plate,
said second minor fluid inlet in said first channel side being positioned between said first minor fluid inlet in said first channel side and said upper edge of said first channel side and being positioned adjacent to said downwardly facing flow directing side of said first plate,
said second minor fluid inlet in said second channel side being positioned between said first minor fluid inlet in said second channel side and said upper edge of said second channel side and positioned adjacent to said downwardly facing flow directing side of said first plate,
said first minor inlet in said first channel side being larger than said second minor inlet in said first channel side and
said first minor inlet in said second channel side being larger than said second minor inlet in said second channel side.

15. A plate settler system comprising
a basin having a fluid inlet and a fluid outlet
a first plate supported in said basin and having a lower edge, an upper edge, an upwardly facing settling side and a downwardly facing flow directing side,
an n^{th} plate supported in said basin and having a lower edge, an upper edge, an upwardly facing settling side and a downwardly facing flow directing side,
a number of intermediate plates, said number being an odd number, said intermediate plates being supported in said basin in parallel spaced relationship with each other, said number of plates each having a lower edge, an upper edge, an upwardly facing settling side and a downwardly facing flow directing side, said number of plates including a center plate with an equal number of intermediate plates on each side thereof,
channel sides cooperating with said first plate, said intermediate plates and said n^{th} plate to define a number of fluid flow channels wherein the number is equal to the number of intermediate plates plus 1, said fluid flow channels each having an inlet and an outlet, and
one hollow channel outlet member supported in said basin and having at least one fluid inlet and at least one fluid outlet,
wherein said outlet member fluid outlet is in communication with said basin fluid outlet,
wherein said outlet member is positioned above said center plate, and
wherein fluid flowing upwardly in each of said number of fluid flow channels enters said at least one fluid inlet.

16. The system claimed in claim 15 wherein said hollow channel outlet member is positioned directly above said upper edge of said center plate.

17. The system claimed in claim 16 wherein said hollow channel outlet member is in contact with said center plate.

18. The system claimed in claim 17 wherein said upper edge of said first plate and said upper edge of said n^{th} plate are higher than the upper edges of each of the intermediate plates.

19. The system claimed in claim 18 wherein said hollow channel outlet member, said first plate and said n^{th} plate are supported in said basin so that said upper edge of said first plate and said upper edge of said n^{th} plate is at least as high as said at least one fluid inlet.
